(19) United States
(12) Patent Application Publication
(10) Pub. No.: US 2026/0189322 A1
(43) Pub. Date: Jul. 2, 2026

(54) MODEM ADJUSTMENT ENGINE(S) FOR MODIFYING A MAXIMUM TRANSMISSION UNIT BASED ON NETWORK LATENCY

(71) Applicant: Oracle International Corporation, Redwood City, CA (US)

(72) Inventor: René Schmitz, Venice, FL (US)

(21) Appl. No.: 19/005,751

(22) Filed: Dec. 30, 2024

(51) Int. Cl. H04L 1/00

(52) U.S. Cl. CPC H04L 1/0018

(57) ABSTRACT

Various embodiments of the present technology generally relate to systems and methods for providing a modem adjustment engine. In an example, the modem adjustment engine determines a connection event between an endpoint and an access point within a network, where the access point facilitates data transmission and routing between the endpoint and the network. Based on the connection event, the modem adjustment engine determines the current latency of the network for the endpoint and a current MTU of a modem associated with the endpoint. Based on the current MTU, and in some cases the current latency of the network, the modem adjustment engine determines an adjusted MTU. Then, the modem adjustment engine adjusts the current MTU of the modem to the adjusted MTU.

### TECHNICAL FIELD

Various embodiments of the present technology generally relate to modems connecting client devices or nodes to networks. More specifically, embodiments of the present technology relate to systems and methods for providing a modem adjustment engine for adjusting a maximum transmission unit (MTU) of a modem to properly align with a network's real-time characteristics.

### BACKGROUND

A modem, short for modulator-demodulator, is a device that enables communication between an endpoint (e.g., client device) and a network by converting digital signals from the device into a format suitable for transmission over the network and vice versa. For example, in the case of a cellular phone connecting to a communications network, the phone's built-in modem facilitates this interaction. The modem processes the phone's digital data and modulates it into radio frequency signals that can travel over the communications network infrastructure, such as cell towers and base stations. Similarly, it demodulates incoming signals from the network back into digital data that the phone can interpret. This seamless exchange allows the cellular phone to send and receive voice, text, and data, ensuring connectivity for calls, internet browsing, and app usage. The modem's ability to handle various frequency bands and protocols is essential for efficient and reliable communication.

To facilitate network communication between the endpoint and the network, a modem typically undergoes an initial configuration during which various parameters are set. One such parameter is the Maximum Transmission Unit (MTU), which determines the largest size, in bytes, of a data packet that can be transmitted without requiring fragmentation. Proper MTU configuration is essential for efficient and reliable data transmission. If the MTU is set too large for the network, packets may need to be fragmented, leading to increased latency and potential packet loss. Conversely, setting the MTU too small can create excessive overhead, requiring more packets to send the same amount of data. In communications networks, optimizing the MTU ensures the modem can balance network limitations with smooth data flow, supporting activities like streaming, browsing, and gaming with minimal interruptions.

Improper MTU settings are often exacerbated when operating within a real-time network environment. That is, latency in network environments can fluctuate on a second-by-second basis due to varying levels of congestion, interference, or dynamic routing paths. In such conditions, an incorrectly configured MTU can significantly degrade performance, particularly in terms of throughput. For instance, if the MTU is set too large, packets may require fragmentation to fit within the network's constraints, increasing processing overhead and compounding delays as fragmented packets are reassembled. This can lead to noticeable issues such as buffering in video streaming, lag in online gaming, or interruptions in Voice over Internet Protocol (VoIP) calls. Conversely, an MTU that is too small can result in excessive fragmentation, where too many small packets burden the network, reducing efficiency and wasting bandwidth. These issues are particularly detrimental in real-time environments where consistent and rapid data flow is critical.

Accordingly, there exists a need for systems and techniques for a modem adjustment engine that automatically adjusts the MTU settings based on the network's real-time environment, as well as the respective client device connected to the network.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing a modem adjustment engine and one or more of its related functions. As described in greater detail below, the modem adjustment engine is in operable communication with a client device that is connected to a network. The modem adjustment engine monitors the established connection between the client device and the network to detect connection events, such as changes to latency within the network. Based on the detected connection event, the modem adjustment engine computes an adjusted MTU tailored to the current environment of the network, such as the current latency or bandwidth of the network.

Once the adjusted MTU is computed, the modem adjustment engine adjusts a modem associated with the connection from a current MTU to the adjusted MTU. This may involve updating the modem and reconnecting the client device to the network at the adjusted MTU. In some cases, if the modem adjustment engine is not able to identify an adjusted MTU capable of providing acceptable performance with the network, such as due to network congestion, latency, or signal strength, the modem adjustment engine may identify other available networks for the client device. If an available network having a strong signal is identified, the modem adjustment engine may compute an MTU for the available network. Then the modem adjustment engine connects the client device to the available network at the computed MTU.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment in which a modem adjustment engine is implemented to adjust an MTU of a modem 106 based on a network environment according to an embodiment herein;

FIG. 2 illustrates an example operational environment in which a modem adjustment engine is implemented to monitor and adjust a MTU of a modem based on the network environment, according to an embodiment herein;

FIG. 3 provides an example modem adjustment engine process, according to an embodiment herein;

FIG. 4 provides another example modem adjustment engine process, according to an embodiment herein;

FIG. 5 illustrates an example operational flow for providing one or more functions of a modem adjustment engine, according to an embodiment herein; and

FIG. 6 shows an example computing device suitable for providing a modem adjustment engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Network communication is the backbone of modern society, seamlessly connecting individuals, businesses, and systems in an ever-evolving digital age. It enables the instantaneous transfer of information across vast distances, powering critical infrastructure, global commerce, education, and social interaction. A prime example is the communications network, which allows billions of people to make phone calls, send messages, and access the internet from virtually anywhere in the world. This network's intricate web of cell towers, satellites, and data centers ensures continuous connectivity, underscoring the vital role of network communication in facilitating daily life and driving innovation in countless fields.

To connect endpoints, such as client devices, to a network, a modem is often utilized as the critical intermediary that enables communication. A modem—short for modulator-demodulator—facilitates this connection by converting digital signals from devices like computers or smartphones into analog signals that can travel across transmission mediums such as telephone lines, cable systems, or fiber optics, and vice versa. This process ensures that data is effectively transmitted and received between the endpoint and the network. For example, in a home internet setup, the modem interfaces with the internet service provider's network to deliver data to connected devices, allowing for seamless activities like web browsing, streaming, and online communication. By performing this essential role, modems are fundamental in bridging the gap between user devices and the expansive network infrastructure.

To facilitate seamless communication with the network, a modem is configured to operate using a set of predefined parameters that dictate how data is transmitted and received. One of these critical parameters is the Maximum Transmission Unit (MTU), which specifies the largest size of a data packet that can be sent over the network in a single transmission, thus without fragmenting the data. The MTU is determined during the modem's setup process and ensures that packet sizes are compatible with the network infrastructure. By adhering to the MTU, the modem prevents data fragmentation, which can lead to inefficiencies or errors in data transmission. However, this parameter, like others, is statically configured and does not adapt to changing network conditions.

Under conventional frameworks, the modem communicates with the network using these preconfigured parameters, including a fixed MTU, regardless of the real-time network environment (e.g., low bandwidth, high congestion). While this static configuration simplifies the modem's operation, it can lead to inefficiencies in scenarios where the network environment deviates from the ideal conditions for which the parameters were set. For instance, in environments with high latency or low bandwidth, a fixed MTU may result in increased packet loss, retransmissions, or excessive overhead due to fragmentation. This mismatch can degrade the quality of service, causing delays, buffering, or reduced throughput for users. Moreover, in congested networks, a fixed MTU might exacerbate the problem by failing to adjust packet sizes to optimize transmission, further straining the network and reducing overall efficiency. These limitations highlight the challenges of relying on fixed parameters in a dynamic and variable network ecosystem.

To address at least these shortcomings of conventional frameworks for modem configuration, in particular, fixed MTUs, an example modem adjustment engine is provided herein. As will be described in greater detail below, a modem adjustment engine monitors a connection between an endpoint (e.g., client device) and a network to which the endpoint is connected. Specifically, the modem adjustment engine monitors one or more of the network's bandwidth, latency, signal strength, and current congestion level. If the modem adjustment engine detects a connection event, such as an increase in latency, a reduction in throughput of the endpoint to the network, data fragmentation, or a drop in signal strength, the modem adjustment engine analyzes whether an adjustment to the MTU of a respective modem would resolve the connection event, or whether the endpoint should switch to another available network.

Based on the connection event, such as a change in the latency of the network, the modem adjustment engine determines a current MTU of the modem associated with the endpoint. In view of the current MTU and/or the connection event, the modem adjustment engine computes an adjusted MTU that reduces or prevents data fragmentation during transactions between the endpoint and the network. Once computed, the modem adjustment engine verifies that the adjusted MTU provides improved communication with the network (e.g., lower latency, less data fragmentation) over the current MTU. If the adjusted MTU improves communication with the network, the modem adjustment engine updates the current MTU to the adjusted MTU for the modem.

By continuously monitoring the network and throughput of the endpoint, the modem adjustment engine adjusts the MTU of the modem to reflect the real-time characteristics of the network, thereby providing numerous benefits in terms of efficiency and performance over conventional frameworks. For example, the modem adjustment engine tailors the MTU of a respective modem to the network's conditions—such as available bandwidth, latency, and packet loss rates—to minimize fragmentation and retransmissions of data. A well-matched MTU ensures that packets are neither too large to traverse the network without fragmentation nor too small to introduce unnecessary overhead from excessive headers. This balance reduces the risk of packet loss and improves throughput, particularly in challenging environments such as high-latency or low-bandwidth networks. Additionally, tailoring the MTU to the network environment enhances the performance of real-time applications like video conferencing or online gaming, where smooth, timely data delivery is crucial. Overall, by adjusting the MTU in real-time to reflect the network's specific characteristics, the modem adjustment engine ensures more reliable and efficient communication, leading to an improved user experience.

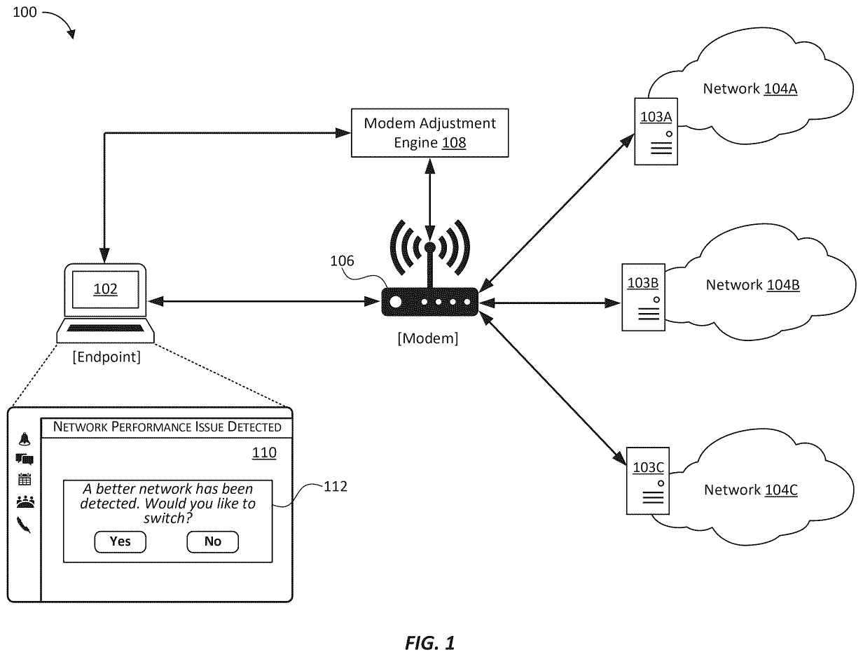

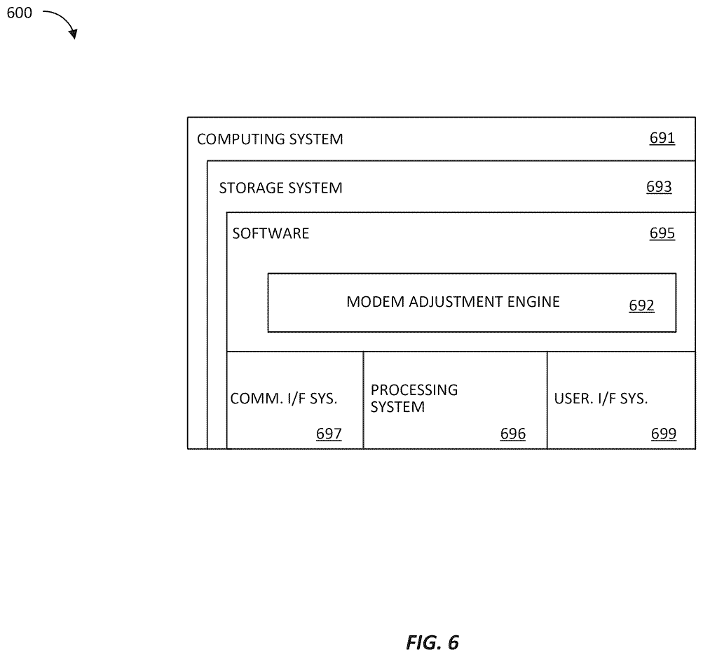

Turning now to the Figures, FIG. 1 illustrates an example operational environment 100 in which a modem adjustment engine 108 may be implemented to adjust an MTU of a modem 106 based on a network environment, according to an embodiment herein. As illustrated, the modem adjustment engine 108 is in operable communication with a client device 102 (e.g., endpoint). In some embodiments, the modem adjustment engine 108 may be locally installed and executed by the client device 102, while in other embodiments, the modem adjustment engine 108 may be remotely located but interact with the client device 102 to provide one or more of the functions described herein. Examples of the client device 102 may include personal computers, tablet computers, mobile phones, gaming consoles, wearable devices, Internet of Things (IoT) devices, and any other suitable devices, of which computing apparatus 691 in FIG. 6 is also broadly representative.

As illustrated, the client device 102 is connected to a network 104A. The network 104A may be a variety of networks, such as a communications network (e.g., a 4G network, a 5G network), or the network 104A may be a local area network (LAN), a wide area network (WAN), a wireless network (e.g., Wi-Fi), a satellite network, or even a hybrid network that integrates multiple technologies for connectivity. The specific type of network 104A can depend on the infrastructure and purpose, ranging from public internet services to private enterprise networks designed for secure communications.

To interact with the network 104A, the client device 102 is in operable communication with a modem 106. As those skilled in the art readily appreciate, the modem 106 serves as a bridge, translating and transmitting the data signals received from the client device 102 into a format compatible with the network 104A's communication protocols. Once the modem 106 processes the data, it communicates directly with an access point 103A of the network 104A. The access point 103A, which can be a server, router, or another form of network infrastructure, validates the modem's 106 request, authenticates the client device 102, and establishes a secure data exchange channel. Through this pathway, the client device 102 gains access to the broader resources and services of network 104A. The modem 106 continuously facilitates two-way communication, ensuring seamless data transmission between the client device 102 and the access point 103A. As noted above, the access point 103A may be a server, examples of which include web servers, application servers, virtual or physical servers, or any combination or variation thereof, of which computing apparatus 691 in FIG. 6 is broadly representative.

As noted above, the modem 106 operates as an intermediary, converting data received from the client device 102 into a format compatible with the protocols and standards of the network 104A. When the client device 102 sends data to the modem 106, the modem 106 performs several functions, including modulation, encoding, and packet structuring. The modem 106 translates the raw digital signals from the client device 102 into signals that align with the communication requirements of the network 104A, ensuring proper signal timing, frequency adjustment, and data integrity during transmission. It should be appreciated that while the modem 106 is illustrated as separate from the client device 102, in some cases, the modem 106 may be integrated as part of the client device 102.

To facilitate this process effectively, the modem 106 is configured with predefined parameters during its setup. One such parameter is the MTU for the modem, which specifies the largest packet size that can be transmitted over the network 104A without requiring fragmentation. Under conventional frameworks, the MTU is established during the initial setup of the modem 106 based on the network's 104A characteristics, ensuring compatibility with the connected infrastructure. The characteristics of the network 104A, however, are constantly changing based on network traffic, resource demands, and environmental conditions, as well as the dynamic behavior of connected devices, such as the client device 102. These fluctuations in the network environment can impact latency, bandwidth availability, and packet loss rates, which in turn influence the overall performance of data transmission between the modem 106 and the network 104A. Additionally, variations in the network topology, such as the introduction of new access points or rerouting of traffic, can further alter the operational parameters of the network, requiring ongoing adaptability for optimal communication.

To address the fluctuations and changes within the network environment, the client device 102 leverages the modem adjustment engine 108. As noted above, the modem adjustment engine 108 adjusts the MTU of the modem 106 to reflect the current network environment. As used herein, the network environment encompasses various performance characteristics of the network 104A, including the available bandwidth of the network 104A, which defines the maximum data transmission capacity between the client device 102 and the network infrastructure. The network environment also includes latency, which refers to the time delay in communication, whether as round-trip latency between the client device 102 and the network 104A or as one-way latency within the network 104A itself. Additionally, the network environment accounts for the throughput of the client device 102, representing the actual data successfully transmitted from the client device 102 to the network 104A over a given period. Other aspects of the network environment may include changes in latency that affects real-time applications, the packet loss rate which measures the percentage of data packets lost during transmission due to congestion or errors, and the signal strength of the network 104A. Changes in network topology, such as the addition of new nodes, reconfiguration of routing paths, or failure of components, are also key factors influencing the network environment.

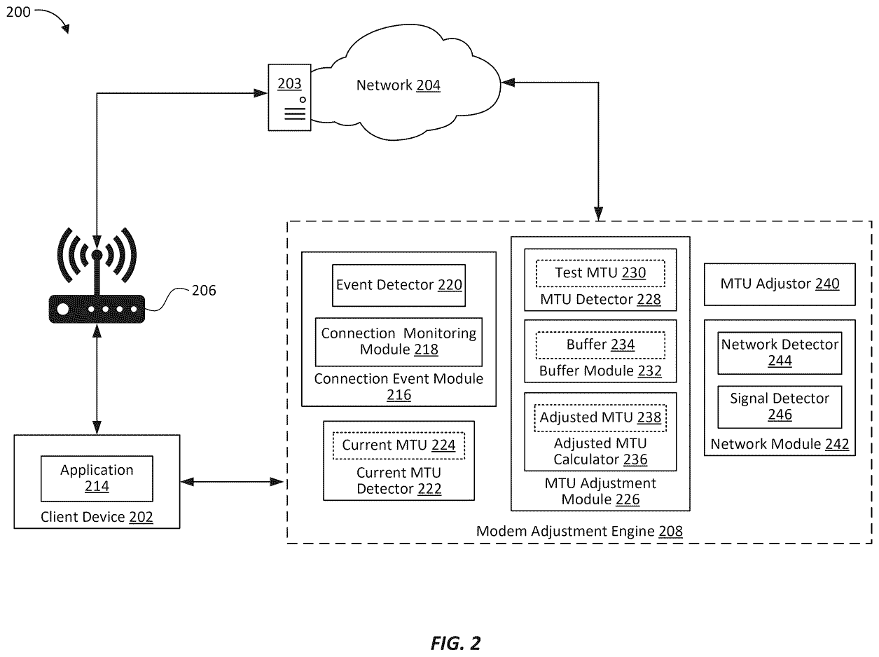

To adjust the MTU of the modem 106, the modem adjustment engine 108 monitors the network environment, in particular the connection between the client device 102 and the network 104A for connection events. Connection events include changes to the network environment that affect the performance of the connection between the client device 102 and the network 104A. Such changes may involve fluctuations in latency, including increased round-trip or one-way delays, which degrade communication efficiency. Other connection events can include variations in available bandwidth, leading to congestion or reduced data transmission rates, and alterations in throughput, which impact the amount of data successfully transferred between the client device 102 and the network 104A. Based on the connection event, the modem adjustment engine 108 computes an adjusted MTU that is tailored to the current network environment. Computation of the adjusted MTU is described in greater detail below with respect to FIGS. 2-5.

Once the adjusted MTU is determined, the modem adjustment engine 108, in some cases, verifies that the adjusted MTU provides better performance than a current MTU of the modem 106. That is, the modem adjustment engine 108 verifies that the adjusted MTU provides one or more of reduced data fragmentation, lower latency, improved throughput of the client device 102, and few transmission errors for the connection between the client device 102 and the network 104A. If the adjusted MTU provides better performance than the current MTU of the modem 106, the modem adjustment engine 108 then adjusts the MTU setting of the modem 106 from the current MTU to the adjusted MTU.

In some cases, the modem adjustment engine 108 may determine that a performance level of the network 104A is such that the client device 102 should switch to another network. That is, the modem adjustment engine 108 may determine that based on the network environment, the connection cannot be improved by adjusting the MTU. For example, the network 104A may be heavily congested, such that even with adjusting the MTU of the modem 106, the client device 102 still experiences one or more of data fragmentation, high latency, low throughput, and transmission errors. As such, the modem adjustment engine 108 may determine available networks 104B-C to which the client device 102 can connect. As illustrated, the available networks 104B-C may be the same or similar to the network 104A, including each having a respective access point 103B-C. It should be appreciated that while only three networks 104A-C are illustrated, any number of networks may be available for connection with the client device 102.

Once identified, the modem adjustment engine 108 determines a signal strength for each of the available networks 104B-C and selects the network 104B having the strongest signal. Then, the modem adjustment engine 108 may determine a MTU appropriate for the network environment of the network 104B at the time of connection. Once the MTU for the network 104B is identified, the modem adjustment engine 108 may prompt the client device 102, via the modem 106 to connect to the network 104B. This process is described in greater detail below.

In some embodiments, prior to disrupting the connection between the client device 102 and the network 104A, the adjustment engine 108 may generate and provide a notification 112 to a user of the client device. For example, as illustrated, the modem adjustment engine 108 may provide the notification 112 via a user interface 110 on the client device 102 indicating that a better network is detected and provide an option to switch from the network 104A to the network 104B. Upon selection of option to switch (e.g., selection of the “Yes” as illustrated), the modem adjustment engine 108 may cause the client device 102 to disconnect from the network 104A and establish a connection with the network 104B. As part of establishing the connection with the network 104B, the modem adjustment engine 108 sets the MTU of the modem 106 to the MTU tailored to the network environment of the network 104B.

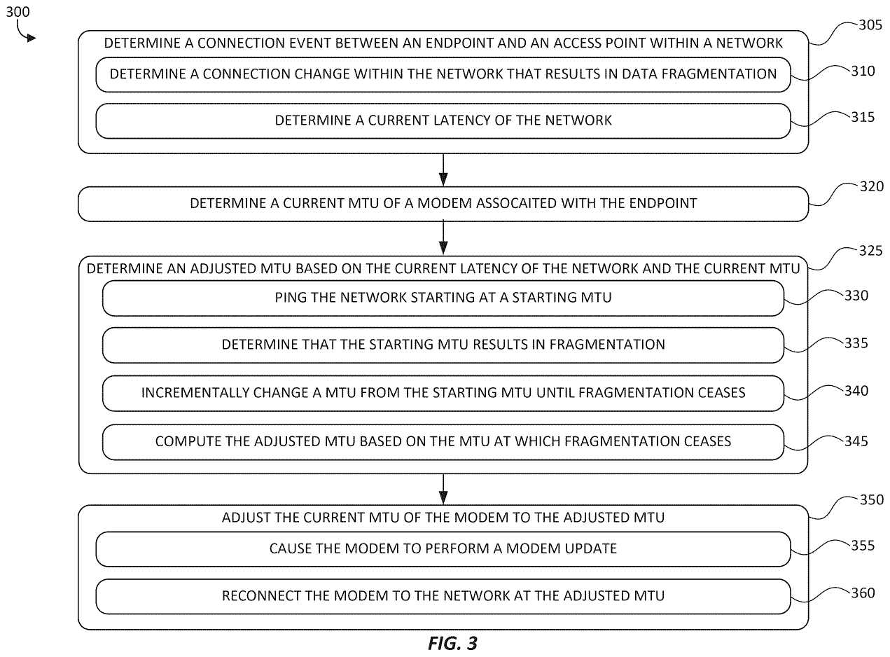

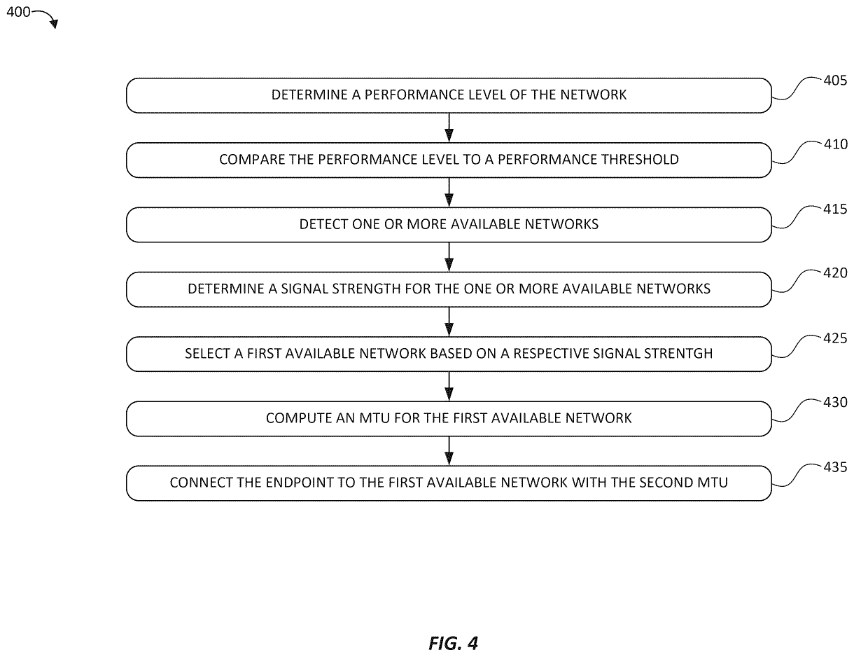

Referring now to FIG. 2, an example operational environment 200 in which a modem adjustment engine 208 is implemented to monitor and adjust a MTU of a modem 206 based on a network environment is provided, according to an embodiment herein. For ease of explanation, FIG. 2 is described in conjunction with FIG. 3 and FIG. 4, which provide example modem adjustment engine processes, in particular processes 300 and 400 for providing the modem adjustment engine 208 and one or more of its functions, respectively, according to an embodiment herein. While FIGS. 3 and 4 are described with relation to FIG. 2, it should be appreciated that components, elements, and steps from any other Figures described herein may be equally applicable. FIG. 2 is initially described with respect to FIG. 3 and then subsequently with respect to FIG. 4.

As illustrated, a client device 202 is connected to a network 204 via a modem 206, which may be the same or similar to the client device 102, the network 104A, and the modem 106, respectively. It should be noted that although the modem 206 is depicted as a separate component from the client device 202, in certain scenarios, the modem 206 may be integrated into the client device 202. For instance, the client device 202 could be a mobile or cellular device with an internal modem 206, enabling seamless connection to the network 204, which may be a communications network.

The client device 202 is in operable communication with the modem adjustment engine 208. As noted above, the modem adjustment engine 208 may be installed and executed locally on the client device 202, allowing for direct interaction with the device's hardware and software resources. Alternatively, in some embodiments, the modem adjustment engine 208 may be executed remotely, such as on a server or cloud infrastructure, while maintaining communication with the client device 202 to perform one or more of the functions described herein.

Specifically, the client device 202 leverages the modem adjustment engine 208 to adjust the MTU of the modem 206 to reflect the real-time characteristics of the network 206. As such, to determine whether the MTU of the modem 206 should be adjusted, the modem adjustment engine 208 may determine a connection event between the client device 202 (e.g., endpoint) and the network 204 (e.g., the access point 203 to the network 204) (305). To detect a connection event, the modem adjustment engine 208 may include a connection event module 216. The connection event module 216 monitors the connection between the client device 202 and the network 104 to determine a real-time network environment. For example, the connection event module 216 includes a connection monitoring module 218 that periodically or continuously measures latency by sending timestamped packets to the network 204 and analyzing the round-trip time. In another example, the connection monitoring module 218 assesses available bandwidth by conducting controlled data transfers, such as sending test packets of varying sizes to the network 204 and evaluating the network's 204 response.

The connection monitoring module 218 may also detect network congestion by monitoring packet loss rates, jitter, or fluctuations in throughput, often using standard network diagnostic protocols such as Internet Control Message Protocol (ICMP) (e.g., ping) or Transmission Control Protocol (TCP) metrics. Additionally, the connection monitoring module 218 can calculate the throughput of the client device 202 by evaluating the actual data successfully transmitted or received over a given time, factoring in retransmissions or delays caused by network conditions.

Based on monitoring of the network 104, an event detector 220 may detect a connection event. That is, the event detector 220 may determine a connection change within the network 204 that results in data fragmentation (310). Specifically, the event detector 220 may detect a change in the network environment, such as a shift in latency, that impacts the characteristics of the connection. For instance, the event detector 220 may determine a change (e.g., fluctuation) in two-way (round-trip) latency or one-way latency within the network 204. These latency changes can disrupt the transmission timing between the modem 206 and the network 204, potentially causing misalignment in packet delivery. Such variations in latency may lead to data fragmentation during transmissions. Data fragmentation occurs when the size of transmitted packets exceeds the MTU of a network link, here the modem 206, often exacerbated by latency-related retransmissions or buffering delays. This fragmentation can negatively affect the connection between the client device 202 and the network 204 by increasing overhead, introducing reassembly errors, or causing higher packet loss rates.

In some embodiments, the modem adjustment engine 208 determines the latency of the network based on the connection event (315). As noted above, the connection event may be a change in latency of the network. Based on the detected change, the event detector 220 may determine the latency of the network at the time of the detected event. Based on the current latency of the network, the modem adjustment engine 208 determines whether or not to adjust the MTU of the modem 206. As noted above, the network environment is in constant fluctuation. As such, the event detector 220 may detect a small fluctuation, such as a small increase in network latency. If the current latency of the network is relatively similar to a previous latency to which the current MTU was tailored to, the modem adjustment engine 208 may determine that the current MTU is sufficient. For example, if the current latency of the network at the time that the connection event is detected is within a threshold range of variation, e.g., 1%, 5%, 10%, 15%, or 20% deviation from the latency to which the current MTU was set by, then the modem adjustment engine 208 may determine that the current MTU is sufficient given the network environment. In contrast, if the change in network latency is such that the current latency is outside the permissible threshold range of variation, the modem adjustment engine may determine that the MTU should be adjusted.

Once the connection event is detected, the modem adjustment engine 208 determines the current MTU 224 of the modem 206 (320). In particular, the modem adjustment engine 208 may include a current MTU detector 222 that determines the current MTU 224 of the modem 206 by directly querying the modem 206 or performing diagnostic tests through the client device 202. When engaging with the modem 206, current MTU detector 222 may use protocols such as Simple Network Management Protocol (SNMP) or device-specific Application Interfaces (APIs) to retrieve the current MTU 224, ensuring accurate and up-to-date information. Alternatively, current MTU detector 222 may initiate diagnostic operations via the client device 202 to identify the current MTU 224.

As illustrated, the modem adjustment engine 208 includes an MTU adjustment module 226. Based on the current latency of the network and the current MTU 224, the MTU adjustment module 226 determines an adjusted MTU 238 for the modem 206 (325). That is, the modem adjustment engine 208 determines the adjusted MTU 238 that is tailored to the network environment based on the current latency of the network 204.

To determine the adjusted MTU 238 the MTU adjustment module 226 includes a MTU detector 228. Specifically, the MTU detector 228 may ping the network 204 to determine a test MTU 230 that is the largest possible value that does not result in data fragmentation given the network environment. To start this process, the MTU detector 228 determines a starting MTU. The starting MTU may be based on the current MTU, such as a predefined increment less than the current MTU. For example, if the current MTU is 1500 bytes, then the MTU detector 228 may start the MTU at 1492 byte, an 8 byte increment less than the current MTU. In other embodiments, the starting MTU may be predefined by the MTU detector 228, such as a starting MTU of 1492 bytes regardless of the current MTU.

Once the starting MTU is determined, the MTU detector 228 pings the network 204 at a starting MTU (330). For example, the MTU detector 228 sends one or more packets in an ICMP Echo Request at the starting MTU to the network 204. A “Don't Fragment” (DF) flag is set for the packet indicating that the network 204 should not fragment the packet. From this “ping,” the MTU detector 228 determines that the starting MTU results in data fragmentation (335). In particular, the MTU detector 228 determines that the starting MTU results in data fragmentation of the packet because the network 204 drops the packet and fails to return an ICMP Echo Reply to the MTU detector 228. In other words, because the packet size at the starting MTU exceeds the starting MTU and the packet includes the DF flag is set, the network 204 does not fragment the packet. Instead, the network 204 drops the packet and no ICMP Echo Reply is returned. In some cases, instead of the ICMP Echo Reply, the network 204 returns an ICMP Destination Unreachable—Fragmentation Needed message to indicate that the packet size exceeds the starting MTU.

Based on the packet size at the packet exceeding the starting MTU, the MTU detector 228 incrementally changes the MTU from the starting MTU until fragmentation ceases (340). That is, the MTU detector 228 may incrementally decrease the MTU from the starting MTU at predefined increments, such as 10 bytes per increment, pinging the network 204 each time until a MTU at which the data is not fragmented is identified. For instance, the MTU detector 228 may decrease the MTU to 1482 bytes from the starting MTU of 1492 bytes, ping the network, and determine that the MTU of 1482 bytes still fragments the packet. Then, the MTU is decreased to 1472 bytes, then 1462 bytes, then 1452 bytes, until a MTU at which data fragmentation ceases is identified.

In some embodiments, after decreasing the MTU down by the predefined increments until a MTU at which fragmentation ceases is identified, the MTU detector 228 may incrementally increase the MTU by smaller increments to ensure that the maximum MTU for the given network environment is identified. For example, if the incremental decreasing of MTUs is performed in increments of 10 bytes, then the subsequent increase of MTUs may be performed in increments of 1 byte, 2 bytes, or 5 bytes. Following the above example, the MTU detector 228 may incrementally ping the network 204 increasing the MTU by 1 byte each time until the test MTU 230 of 1458 bytes is identified as the largest MTU at which data does not fragment under the current network environment. As can be appreciated, the increments described herein are illustrative and any increment may be used.

Once the test MTU 230 is identified, the MTU adjustment module 226 computes the adjusted MTU 238 based on the test MTU 230 (345). To compute the adjusted MTU 238, the MTU adjustment module 226 includes a buffer module 232 and an adjusted MTU calculator 236. The buffer module 232 determines a buffer 234 for the adjusted MTU 238. The buffer 234 is a buffer MTU amount that accounts for additional data that may be included in the payload during communication between the client device 202 and the network 204. The type and amount of this additional data can vary depending on the nature of the connection. For instance, packets exchanged between the client device 202 and the network 204 include headers that encapsulate the payload, contributing to the total packet size.

The size of these headers depends on the protocol stack used. In an IP-based connection, each packet includes an IP header—typically 20 bytes for IPv4 or 40 bytes for IPv6—which contains essential routing information, such as source and destination IP addresses, version, and fragmentation flags. Additionally, if the packet involves ICMP, such as for a ping request, it includes an ICMP header, generally 8 bytes in size, with fields like message type, code, checksum, and identifiers for matching requests and replies. Combined, these headers reduce the available payload space (e.g., by 28 bytes), a constraint that becomes more significant in connections with additional encapsulation layers, such as tunneling or encryption, where extra headers are appended. Therefore, the buffer module 232 calculates the buffer 234 to account for the space required by these headers, ensuring the total packet size does not exceed the allowable limits, which could otherwise result in fragmentation or dropped packets.

The adjusted MTU calculator 236 then calculates the adjusted MTU 238 based on the buffer 234 and the test MTU 230. In particular, the adjusted MTU calculator 236 adds the buffer 234 to the test MTU 230 to determine the adjusted MTU 238. Following the above example, if the test MTU 230 is 1458 bytes and the buffer is 28 bytes, the adjusted MTU calculator 236 may compute the adjusted MTU 238 to be 1486 bytes.

Responsive to computing the adjusted MTU 238, the modem adjustment engine 208 may verify that the adjusted MTU 238 provides a better connection between the client device 202 and the network 204 than the current MTU 224. For example, the modem adjustment engine 208 may ping the network 204 at the current MTU 224 and then ping the network 204 at the adjusted MTU 238 and compare the latency between the two interactions. If the adjusted MTU 238 provides a lower latency than the current MTU 224, then the modem adjustment engine 208 may continue on to updating the modem 206 to the adjusted MTU 238. However, if the modem adjustment engine 208 determines that the adjusted MTU 238 does not provide better performance (e.g., lower latency) than the current MTU 224, then the modem adjustment engine 208 may perform one or more of the above steps to determine if a subsequent adjusted MTU provides better performance. Or, as will be described in greater detail below, the modem adjustment engine 208 may determine that the client device 202 should switch to another network based on performance level of the network 204.

As noted above, if the adjusted MTU 238 is verified as providing improved performance over the current MTU 224, the modem adjustment engine 208 may adjust the current MTU 224 of the modem 206 to the adjusted MTU 238 (350). In particular, the modem adjustment engine 208 may include an MTU adjustor 240 that adjusts the MTU of the modem 206 to the adjusted MTU 238. In some embodiments, the MTU adjustor 240 may initially determine whether or not to adjust the MTU based on the current activity of the client device 202. The MTU adjustor 240 evaluates the status of the client device 202, such as whether an application 214 running on the client device 202 is actively engaging with the network 204. This interaction may involve activities such as uploading or downloading content, streaming data, or performing other network-dependent operations. By monitoring these activities, the MTU adjustor 240 determines the extent and nature of the client device's 202 and/or application's 214 reliance on the network 204 at a given moment. Based on this assessment, the MTU adjustor 240 determines whether to proceed with adjusting the MTU immediately or deferring it to a later time.

In an embodiment, the MTU adjustor 240 may determine that a current transmission between the application 214 and the network 204 is a time sensitive transmission. As such, the MTU adjustor 240 may refrain from adjusting the MTU until the transmission is completed. At which point, the MTU adjustor 240 may proceed with adjusting the MTU as described below. In contrast, if the MTU adjustor 240 determines that the transmission is not time sensitive or of lower priority, the MTU adjustor 240 may notify the application 214 to pause the transmission and the proceed with adjusting the MTU. After the MTU is adjusted, as described below, the MTU adjustor 240 may notify the application 214 to reinitiate the transmission.

To adjust the MTU, the MTU adjustor 240 may cause the modem 206 to perform a modem update to the adjusted MTU 238 (355). In an example, to initiate a modem update of the modem 206, the MTU adjustor 240 may trigger a reconfiguration process that typically involves communicating with the modem's 206 management interface. For example, the MTU adjustor 240 may interact with the modem 206 through network management protocols such as SNMP, device-specific APIs, or by accessing the modem's 206 configuration settings directly via a command-line interface (CLI) or web-based GUI. During the update process, the MTU adjustor 240 may send a command or instruction to the modem 206 specifying the adjusted MTU 238, which the modem 206 in turn applies to its internal routing and packet-handling logic. In some cases, the modem 206 may need to temporarily suspend or restart the modem's 206 network services to ensure the adjusted MTU 238 is propagated across the connection with the client device 202 and any intermediate network nodes. As such, the modem adjustment engine 208 may be required to reconnect the modem 206 to the network 204 at the adjusted MTU 238 after the update is complete (360).

Turning now to FIG. 4 with reference to FIG. 2, in some embodiments, the modem adjustment engine 208 may determine that a performance level of the network 204 is below a performance threshold and/or that a network having better performance is available for the client device 202. As such, the modem adjustment engine 208 may identify another network having better performance than the network 204 and prompt the client device 202 to switch to the better network.

In an example, the modem adjustment engine 208 determines a performance level of the network 204 (405). That is, the modem adjustment engine 208 evaluates the performance level of the network 204 by collecting and analyzing real-time metrics related to network behavior. This process involves monitoring key performance indicators such as latency, bandwidth availability, jitter, and packet loss rates. The modem adjustment engine 208 may initiate diagnostic operations, such as sending test packets or measuring round-trip times, to gauge network responsiveness and reliability. Additionally, the modem adjustment engine 208 may analyze throughput by comparing the amount of data successfully transmitted between the client device 202 and the network 204 over a specific period. The modem adjustment engine 208 may also incorporate data from passive monitoring, such as logs of historical network activity, or feedback from other network devices, like routers or access points, to create a comprehensive assessment of network performance. These metrics are then processed to determine the overall performance level of the network 204, which serves as the basis for further decisions or adjustments.

Once the performance level is determined, the modem adjustment engine 208 may compare the performance level to a performance threshold (410). That is, after determining the performance level of the network 204, the modem adjustment engine 208 compares the performance level of the network 204 against a performance threshold, which may be predetermined by the client device 202 or defined based on application-specific requirements. This performance threshold represents the minimum acceptable network performance level, encompassing parameters such as maximum allowable latency, minimum bandwidth, acceptable jitter levels, and tolerable packet loss rates. The comparison involves evaluating whether the current performance metrics meet or exceed the predefined threshold. For instance, if latency exceeds the acceptable limit or bandwidth falls below the minimum requirement, the network 204 may be classified as underperforming. The performance threshold may be tailored to the operational demands of the client device 202 and/or the application 214, ensuring that the comparison aligns with its intended usage, such as streaming, gaming, or large data uploads. This analysis allows the modem adjustment engine 208 to determine whether the network 204 is performing within expected parameters or if adjustments or optimizations are necessary to maintain reliable and efficient connectivity.

If the modem adjustment engine 208 determines that the performance level of the network 204 is below the performance threshold, the modem adjustment engine 208 may determine one or more available networks (415). As illustrated, the modem adjustment engine 208 may include a network module 242 containing a network detector 244. The network detector 244 continuously monitors the environment to identify other available networks to which the client device 202 can potentially connect. Upon detecting available networks, such as networks 104B-C, a signal detector 246, integrated within the network module 242, evaluates the signal strength of each network. In scenarios involving communications networks, such as cellular networks, the signal detector 246 measures signal strength in decibels (dBm), a logarithmic unit that quantifies the power level of the received signal. These measurements typically range from approximately −30 dBm to −110 dBm, where values closer to 0 indicate stronger signal strength. For instance, a signal strength of −30 dBm represents an excellent connection, while −110 dBm denotes a weak or unusable signal. The signal detector 246 may also apply predefined thresholds to classify signal quality, with a strength above −85 dBm often considered adequate for a reliable connection in many use cases.

Based on the signal strength of the available networks, the modem adjustment engine 208 may select a first available network having the strongest signal (425). Once the first available network is selected, the modem adjustment engine 208 may compute a MTU based on the network environment of the first available network (430). The MTU for the first available network is computed using one or more of the steps described above. For example, the modem adjustment engine 208 may ping the first available network with a starting MTU and the incrementally change the MTU until a test MTU at which data fragmentation ceases is identified for the first available network. Then, the modem adjustment engine 208 may determine the buffer 234 and then compute the MTU for the first available network based on the buffer 234 and the test MTU 230.

Once the MTU for the first available network is determined, the modem adjustment engine 208 may prompt the client device 202 to connect to the first available network at the MTU. As described above, this may involve the modem adjustment engine 208 notifying a user of the client device 202 of the identified first available network and requesting approval to switch from the network 204 to the first available network. If the user indicates to switch between networks, the modem adjustment engine 208 may connect the client device 202 to the first available network, configuring the modem 206 at the identified MTU (435). In some embodiments, the modem adjustment engine 208 may automatically switch to the first available network based on the performance level of the network 204. As can be appreciated this may minimize disruptions caused by poor performance of the network 204.

In some embodiments, instead of switching between networks, the modem adjustment engine 208 may throttle any data transmissions occurring between the client device 202 and the network 204 during periods of poor performance, such as high latency. For example, upon detecting high latency within the network 204, the modem adjustment engine 208 may determine a data transmission occurring from the client device 202 to the network 204, or vice versa. Then the modem adjustment engine 208 may determine a priority or urgency of the data transmission. This may involve the modem adjustment engine 208 querying a respective application 214 to determine the priority and/or urgency of the data transmission. If the modem adjustment engine 208 determines that the data transmission is not urgent, then the modem adjustment engine 208 may pause the data transmission until the latency of the network 204 improves. Once the modem adjustment engine 208 determines that the latency of the network 204 (or other performance issue) is improved or resolved, the modem adjustment engine 208 may reinitiate the data transmission. Not only does this provide an improved user experience, but by waiting until the network environment is improved to reinstate the data transmission, the modem adjustment engine 208 improves the overall congestion and bandwidth of the network 204, thereby improving the network for other connected devices.

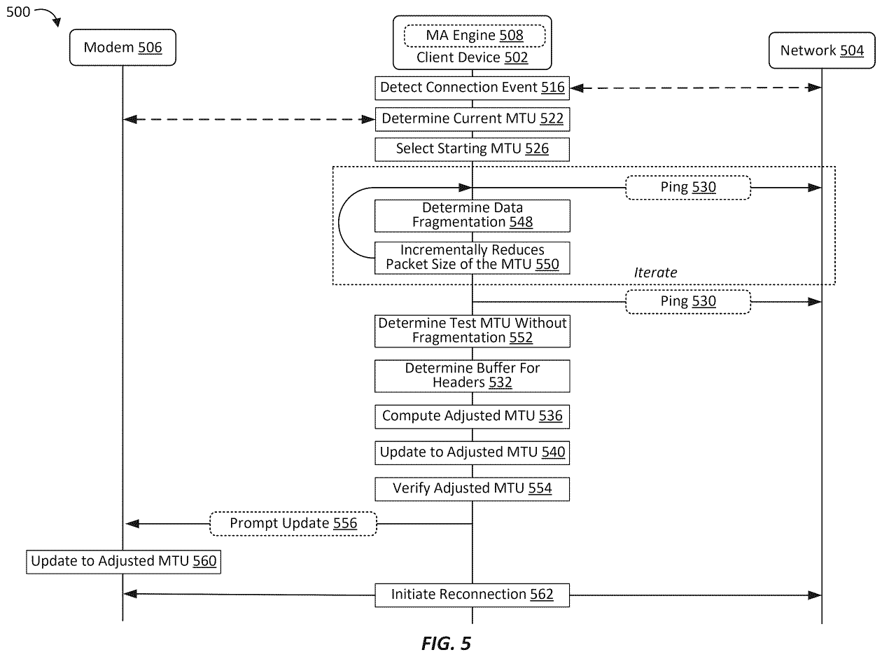

Referring now to FIG. 5, an example operational flow 500 for providing one or more functions of a modem adjustment engine 508 is illustrated, according to an embodiment herein. As illustrated, a client device 502 includes a modem adjustment (MA) engine 508, which may be the same or similar to the client device 202 and the modem adjustment engine 208, respectively, for adjusting a MTU based on real-time network characteristics. The client device 202 is connected to a network 504 via a modem 506, which may be the same as the network 204 and the modem 206, respectively.

As illustrated, the modem adjustment engine 208 detects a connection event (516), such as detecting a change in latency within a network 504, which may be the same or similar to the network 204. Based on the detected connection event, the modem engine 508 the modem adjustment engine 508 determines a current MTU of the modem 506 (522). Then, the modem adjustment engine 508 selects a starting MTU (526), which in some embodiments is based on the current MTU. Using the starting MTU, the modem adjustment engine 208 may ping the network 504 (530) by sending one or more packets of various sizes at the starting MTU. Based on the network's 504 response (or lack thereof), the modem adjustment engine 508 determines that data fragmentation occurs at the starting MTU (548). As such, the modem adjustment engine 508 incrementally reduces the packet size of the MTU (550), iteratively pinging the network 504 with each incrementally lower MTU (530).

When a test MTU is identified at which data fragmentation ceases (552), the modem adjustment engine 508 may determine a buffer for the headers (532). As mentioned earlier, the headers for different types of data transmissions can vary based on the specific network 504 being used and/or the type of connection established between the client device 502 and the network 504. As such, the modem adjustment engine 508 may determine the type of connection and/or type of data transmission occurring and determine the buffer responsively. Based on the buffer and the test MTU, the modem adjustment engine 508 computes the adjusted MTU (536).

Responsive to computing the adjusted MTU, the modem adjustment engine 508 updates the modem 506 to the adjusted MTU (540). In some cases, the modem adjustment engine 508 verifies that the adjusted MTU provides lower latency than the current MTU prior to updating the modem 506 to the adjusted MTU (554). Once the adjusted MTU is verified, the modem adjustment engine 508 may prompt the modem 506 to update (556). As illustrated, responsive to the prompt, the modem 506 updates its configuration to the adjusted MTU (560). In some embodiments, to complete the update process, the modem 506 may temporarily suspend or restart the modem's 206 network services. As such, the modem adjustment engine 508 initiates reconnection of the client device 502, via the modem 506, to the network 504 at the adjusted MTU (562).

Referring now to FIG. 6, is a diagram of a system 600 configured to implement a modem adjustment engine, according to an embodiment herein. The system 600 may be an example of an apparatus including a computing apparatus 691 that is representative of any system or collection of systems in which the various processes, systems, programs, services, and scenarios disclosed herein may be implemented. For example, computing apparatus 691 may be an example modem adjustment engine, such as the modem adjustment engine 108, 208, or 508, a client device, such as the client device 102, 202, or 502, or any of the subcomponents depicted in the operational environment 100, the operational environment 200, or the method or flows 300, 400, or 500, respectively. Examples of computing apparatus 691 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 691 may be implemented as a single apparatus, system, or device or may be implemented in a distributed manner as multiple apparatuses, systems, or devices. Computing apparatus 691 may include, but is not limited to, processing system 696, storage system 693, software 695, communication interface system 697, and user interface system 699. Processing system 696 may be operatively coupled with storage system 693, communication interface system 697, and user interface system 699.

Processing system 696 may load and execute software 695 from storage system 693. Software 695 may include a modem adjustment engine 692, which may be representative of any of the operations for providing a modem adjustment engine or any of its related functions, as discussed with respect to the preceding figures. When executed by processing system 696, software 695 may direct processing system 696 to operate as described herein for at least the various processes, such as the process 300 or the flow 400, operational scenarios, and sequences discussed in the foregoing implementations. Computing apparatus 691 may optionally include additional devices, features, or functionality not discussed for purposes of brevity.

In some embodiments, processing system 696 may comprise a micro-processor and other circuitry that retrieves and executes software 695 from storage system 693. Processing system 696 may be implemented within a single processing device but may also be distributed across multiple processing devices or sub-systems that cooperate in executing program instructions. Examples of processing system 696 may include general purpose central processing units, graphical processing units, application specific processors, and logic devices, as well as any other type of processing device, combinations, or variations thereof.

Storage system 693 may comprise any memory device or computer-readable storage medium readable by processing system 696 and capable of storing software 695. Storage system 693 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 693 may also include computer readable communication media over which at least some of software 695 may be communicated internally or externally. Storage system 693 may be implemented as a single storage device but may also be implemented across multiple storage devices or sub-systems co-located or distributed relative to each other. Storage system 693 may comprise additional elements, such as a controller, capable of communicating with processing system 696 or possibly other systems.

Software 695 (including the modem adjustment engine 692 among other functions) may be implemented in program instructions that may, when executed by processing system 696, direct processing system 696 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 695 may include additional processes, programs, or components, such as operating system software, virtualization software, or other application software. Software 695 may also comprise firmware or some other form of machine-readable processing instructions executable by processing system 696.

In general, software 695 may, when loaded into processing system 696 and executed, transform a suitable apparatus, system, or device (of which computing apparatus 691 is representative) overall from a general-purpose computing system into a special-purpose computing system as described herein. Indeed, encoding software 695 on storage system 693 may transform the physical structure of storage system 693. The specific transformation of the physical structure may depend on various factors in different implementations of this description. Examples of such factors may include, but are not limited to, the technology used to implement the storage media of storage system 693 and whether the computer-storage media are characterized as primary or secondary storage, as well as other factors.

For example, if the computer-readable storage medium is implemented as semiconductor-based memory, software 695 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 697 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 691 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing a modem adjustment engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for” but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a modem adjustment engine that is in operable communication with an endpoint connected to a network, such that the processor-executable instructions, when executed by the one or more processors, direct the computing apparatus, to at least: determine a current MTU of the endpoint, wherein an MTU defines a largest packet size that can be transmitted without fragmentation by the endpoint along a network path within the network; detect a change in latency within the network; determine an adjusted MTU for the endpoint based on the change in latency within the network; and change the current MTU of the endpoint to the adjusted MTU.

Example 2 is the computing apparatus of any previous or subsequent Example, wherein the processor-executable instructions to determine an adjusted MTU for the endpoint based on the change in latency within the network, when executed by the one or more processors, further direct the computing apparatus to: ping the network starting at a starting MTU; determine that the starting MTU results in data fragmentation; incrementally decrease a MTU from the starting MTU until a test MTU at which data fragmentation ceases is identified; and compute the adjusted MTU based on the test MTU at which fragmentation ceases.

Example 3 is the computing apparatus of any previous or subsequent Example, wherein the processor-executable instructions to detect a change in latency within the network, when executed by the one or more processors, further direct the computing apparatus to: determine a change in throughput of the endpoint to the network; and determine the change in latency within the network based on the change in throughout.

Example 4 is the computing apparatus of any previous or subsequent Example, wherein the processor-executable instructions, when executed by the one or more processors, further direct the computing apparatus to: determine an application executing on the endpoint; determine a data transmission requirement for the application to transmit data to the network; determine a performance level of the network; and modify an upload timing based on the data transmission requirement and the performance level of the network.

Example 5 is the computing apparatus of any previous or subsequent Example, wherein the processor-executable instructions to detect a change in latency within the network, when executed by the one or more processors, further direct the computing apparatus to: continuously monitor the network for changes in at least one of: available bandwidth; signal strength of the network; and current congestion level of the network.

Example 6 is the computing apparatus of any previous or subsequent Example, wherein the network comprises a communications network and the endpoint comprises a cellular device.

Example 7 is a method comprising: determining, by a modem adjustment engine, a connection event between an endpoint and an access point within a network, wherein the access point facilitates data transmission and routing between the endpoint and the network; determining, by the modem adjustment engine, a current latency of the network for the endpoint; determining, by the modem adjustment engine, a current MTU of a modem associated with the endpoint; determining, by the modem adjustment engine, an adjusted MTU based on the current latency of the network and the current MTU; and adjusting, by the modem adjustment engine, the current MTU of the modem to the adjusted MTU.

Example 8 is the method of any previous or subsequent Example, wherein determining, by the modem adjustment engine, the adjusted MTU based on the current latency of the network and the current MTU comprises: computing, by the modem adjustment engine, the adjusted MTU based on the latency of the network; and verifying, by the modem adjustment engine, that the adjustment MTU provides lower latency than the current MTU.

Example 9 is the method of any previous or subsequent Example, wherein determining the adjusted MTU based on the current latency of the network and the current MTU comprises: incrementally modifying an MTU of the modem; determining a test MTU at which fragmentation of data ceases; determining a buffer MTU amount; and computing the adjusted MTU based on the test MTU at which fragmentation of data ceases and the buffer MTU amount.

Example 10 is the method of any previous or subsequent Example, wherein adjusting, by the modem adjustment engine, the current MTU of the modem to the adjusted MTU comprises: performing, by the modem adjustment engine, a modem update for the modem; and reconnecting, by the modem adjustment engine, the modem to the network at the adjusted MTU.

Example 11 is the method of any previous or subsequent Example, wherein the method further comprises: determining, by the modem adjustment engine, that latency within the network is above a latency threshold; detecting, by the modem adjustment engine, one or more available networks; determining, by the modem adjustment engine, a signal strength for the one or more available networks; selecting, by the modem adjustment engine, a first available network of the one or more available networks based on a respective signal strength; computing, by the modem adjustment engine, a second MTU for the first available network; and connecting, by the modem adjustment engine, the endpoint to the first available network via the modem set at the second MTU.

Example 12 is the method of any previous or subsequent Example, wherein the network comprises a communications network.

Example 13 is the method of any previous or subsequent Example, wherein the endpoint comprises an edge device, wherein the edge device provides network connectivity to one or more client devices.

Example 14 is a computer-readable storage medium comprising processor-executable instructions, wherein the processor-executable instructions, in part, to operate a modem adjustment engine that is in operable communication with a modem to connect an endpoint to a network, such to cause one or more processors to: determine, by the modem adjustment engine, a current MTU of the endpoint, wherein the MTU defines a largest packet size that can be transmitted without data fragmentation by the endpoint along a network path within the network; detect, by the modem adjustment engine, a connection change within the network that results in data fragmentation; determine, by the modem adjustment engine, an adjusted MTU for the endpoint based on the connection change; change, by the modem adjustment engine, the current MTU of the endpoint to the adjusted MTU; and reconnect, by the modem adjustment engine, the endpoint to the network at the adjusted MTU.

Example 15 is the computer-readable storage medium of any previous or subsequent Example, wherein the processor-executable instructions to determine, by the modem adjustment engine, the adjusted MTU for the endpoint based on the connection change cause the one or more processors to further execute processor-executable instructions stored in the computer-readable storage medium to: ping, by the modem adjustment engine, the network starting at a starting MTU; determine, by the modem adjustment engine, that the starting MTU results in fragmentation; incrementally change, by the modem adjustment engine, a MTU from the starting MTU; ping, by the modem adjustment engine, the network at each incremental change in MTU; identify, by the modem adjustment engine, a test MTU at which fragmentation ceases; and compute, by the modem adjustment engine, the adjusted MTU based on the test MTU at which fragmentation ceases.

Example 16 is the computer-readable storage medium of any previous or subsequent Example, wherein the processor-executable instructions cause the one or more processors to further execute processor-executable instructions stored in the computer-readable storage medium to: detect, by the modem adjustment engine, one or more available networks; determine, by the modem adjustment engine, a signal strength for the one or more available networks; select, by the modem adjustment engine, a first available network of the one or more available networks based on a respective signal strength; compute, by the modem adjustment engine, the current MTU for the first available network; and connect, by the modem adjustment engine, the endpoint to the first available network via the modem set at the current MTU, wherein the first available network comprises the network.

Example 17 is the computer-readable storage medium of any previous or subsequent Example, wherein the processor-executable instructions to detect, by the modem adjustment engine, the connection change within the network that results in data fragmentation cause the one or more processors to further execute processor-executable instructions stored in the computer-readable storage medium to: continuously monitor, by the modem adjustment engine, at least one network conditions to determine the change that results in data fragmentation, wherein the at least one network conditions comprise: an available bandwidth of the network; signal strength of the network; or a congestion level of the network.

Example 18 is the computer-readable storage medium of any previous or subsequent Example, wherein the processor-executable instructions cause the one or more processors to further execute processor-executable instructions stored in the computer-readable storage medium to: determine, by the modem adjustment engine, an application executing on the endpoint; determine, by the modem adjustment engine, a data transmission from the application to the network; determine, by the modem adjustment engine, a performance level of the network; and pause at a first time, by the modem adjustment engine, the data transmission from the application to the network based on the performance level; and reinitiate, by the modem adjustment engine, the data transmission from the application to the network at a second time, wherein the second time is after the first time.

Example 19 is the computer-readable storage medium of any previous or subsequent Example, wherein the processor-executable instructions cause the one or more processors to further execute processor-executable instructions stored in the computer-readable storage medium to: determine, by the modem adjustment engine, that a performance level of the network is below a performance threshold; detect, by the modem adjustment engine, one or more available networks; determine, by the modem adjustment engine, a signal strength for the one or more available networks; select, by the modem adjustment engine, a first available network of the one or more available networks based on a respective signal strength; compute, by the modem adjustment engine, a second MTU for the first available network; and connect, by the modem adjustment engine, the endpoint to the first available network via the modem set at the second MTU.

Example 20 is the computer-readable storage medium of any previous or subsequent Example, wherein the processor-executable instructions to determine, by the modem adjustment engine, the adjusted MTU for the endpoint based on the connection change cause the one or more processors to further execute processor-executable instructions stored in the computer-readable storage medium to: incrementally modify, by the modem adjustment engine, a packet size to identify a test MTU at which fragmentation of data ceases; determine, by the modem adjustment engine, a buffer MTU amount; and compute, by the modem adjustment engine, the adjusted MTU based on the test MTU at which fragmentation of data ceases and the buffer MTU amount.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a modem adjustment engine that is in operable communication with an endpoint connected to a network, such that the processor-executable instructions, when executed by the one or more processors, direct the computing apparatus, to at least:
determine a current MTU of the endpoint, wherein an MTU defines a largest packet size that can be transmitted without fragmentation by the endpoint along a network path within the network;
detect a change in latency within the network;
determine an adjusted MTU for the endpoint based on the change in latency within the network; and
change the current MTU of the endpoint to the adjusted MTU.

2. The computing apparatus of claim 1, wherein the processor-executable instructions to determine an adjusted MTU for the endpoint based on the change in latency within the network, when executed by the one or more processors, further direct the computing apparatus to:
ping the network starting at a starting MTU;
determine that the starting MTU results in data fragmentation;
incrementally decrease a MTU from the starting MTU until a test MTU at which data fragmentation ceases is identified; and
compute the adjusted MTU based on the test MTU at which fragmentation ceases.

3. The computing apparatus of claim 1, wherein the processor-executable instructions to detect a change in latency within the network, when executed by the one or more processors, further direct the computing apparatus to:
determine a change in throughput of the endpoint to the network; and
determine the change in latency within the network based on the change in throughout.

4. The computing apparatus of claim 1, wherein the processor-executable instructions, when executed by the one or more processors, further direct the computing apparatus to:
determine an application executing on the endpoint;
determine a data transmission requirement for the application to transmit data to the network;
determine a performance level of the network; and
modify an upload timing based on the data transmission requirement and the performance level of the network.

5. The computing apparatus of claim 1, wherein the processor-executable instructions to detect a change in latency within the network, when executed by the one or more processors, further direct the computing apparatus to:
continuously monitor the network for changes in at least one of:
available bandwidth;
signal strength of the network; and
current congestion level of the network.

6. The computing apparatus of claim 1, wherein the network comprises a communications network and the endpoint comprises a cellular device.

7. A method comprising:
determining, by a modem adjustment engine, a connection event between an endpoint and an access point within a network, wherein the access point facilitates data transmission and routing between the endpoint and the network;
determining, by the modem adjustment engine, a current latency of the network for the endpoint;
determining, by the modem adjustment engine, a current MTU of a modem associated with the endpoint;
determining, by the modem adjustment engine, an adjusted MTU based on the current latency of the network and the current MTU; and
adjusting, by the modem adjustment engine, the current MTU of the modem to the adjusted MTU.

8. The method of claim 7, wherein determining, by the modem adjustment engine, the adjusted MTU based on the current latency of the network and the current MTU comprises:
computing, by the modem adjustment engine, the adjusted MTU based on the latency of the network; and
verifying, by the modem adjustment engine, that the adjustment MTU provides lower latency than the current MTU.

9. The method of claim 7, wherein determining the adjusted MTU based on the current latency of the network and the current MTU comprises:
incrementally modifying an MTU of the modem;
determining a test MTU at which fragmentation of data ceases;
determining a buffer MTU amount; and
computing the adjusted MTU based on the test MTU at which fragmentation of data ceases and the buffer MTU amount.

10. The method of claim 7, wherein adjusting, by the modem adjustment engine, the current MTU of the modem to the adjusted MTU comprises:
performing, by the modem adjustment engine, a modem update for the modem; and
reconnecting, by the modem adjustment engine, the modem to the network at the adjusted MTU.

11. The method of claim 7, wherein the method further comprises:
determining, by the modem adjustment engine, that latency within the network is above a latency threshold;
detecting, by the modem adjustment engine, one or more available networks;
determining, by the modem adjustment engine, a signal strength for the one or more available networks;
selecting, by the modem adjustment engine, a first available network of the one or more available networks based on a respective signal strength;
computing, by the modem adjustment engine, a second MTU for the first available network; and
connecting, by the modem adjustment engine, the endpoint to the first available network via the modem set at the second MTU.

12. The method of claim 7, wherein the network comprises a communications network.

13. The method of claim 7, wherein the endpoint comprises an edge device, wherein the edge device provides network connectivity to one or more client devices.

14. A computer-readable storage medium comprising processor-executable instructions, wherein the processor-executable instructions, in part, to operate a modem adjustment engine that is in operable communication with a modem to connect an endpoint to a network, such to cause one or more processors to:
determine, by the modem adjustment engine, a current MTU of the endpoint, wherein the MTU defines a largest packet size that can be transmitted without data fragmentation by the endpoint along a network path within the network;
detect, by the modem adjustment engine, a connection change within the network that results in data fragmentation;
determine, by the modem adjustment engine, an adjusted MTU for the endpoint based on the connection change;
change, by the modem adjustment engine, the current MTU of the endpoint to the adjusted MTU; and
reconnect, by the modem adjustment engine, the endpoint to the network at the adjusted MTU.

15. The computer-readable storage medium of claim 14, wherein the processor-executable instructions to determine, by the modem adjustment engine, the adjusted MTU for the endpoint based on the connection change cause the one or more processors to further execute processor-executable instructions stored in the computer-readable storage medium to:
ping, by the modem adjustment engine, the network starting at a starting MTU;
determine, by the modem adjustment engine, that the starting MTU results in fragmentation;
incrementally change, by the modem adjustment engine, a MTU from the starting MTU;
ping, by the modem adjustment engine, the network at each incremental change in MTU;
identify, by the modem adjustment engine, a test MTU at which fragmentation ceases; and
compute, by the modem adjustment engine, the adjusted MTU based on the test MTU at which fragmentation ceases.

16. The computer-readable storage medium of claim 14, wherein the processor-executable instructions cause the one or more processors to further execute processor-executable instructions stored in the computer-readable storage medium to:
detect, by the modem adjustment engine, one or more available networks;
determine, by the modem adjustment engine, a signal strength for the one or more available networks;
select, by the modem adjustment engine, a first available network of the one or more available networks based on a respective signal strength;
compute, by the modem adjustment engine, the current MTU for the first available network; and
connect, by the modem adjustment engine, the endpoint to the first available network via the modem set at the current MTU, wherein the first available network comprises the network.

17. The computer-readable storage medium of claim 14, wherein the processor-executable instructions to detect, by the modem adjustment engine, the connection change within the network that results in data fragmentation cause the one or more processors to further execute processor-executable instructions stored in the computer-readable storage medium to:
continuously monitor, by the modem adjustment engine, at least one network conditions to determine the change that results in data fragmentation, wherein the at least one network conditions comprise:
an available bandwidth of the network;
signal strength of the network; or
a congestion level of the network.

18. The computer-readable storage medium of claim 14, wherein the processor-executable instructions cause the one or more processors to further execute processor-executable instructions stored in the computer-readable storage medium to:
determine, by the modem adjustment engine, an application executing on the endpoint;
determine, by the modem adjustment engine, a data transmission from the application to the network;
determine, by the modem adjustment engine, a performance level of the network; and
pause at a first time, by the modem adjustment engine, the data transmission from the application to the network based on the performance level; and
reinitiate, by the modem adjustment engine, the data transmission from the application to the network at a second time, wherein the second time is after the first time.

19. The computer-readable storage medium of claim 14, wherein the processor-executable instructions cause the one or more processors to further execute processor-executable instructions stored in the computer-readable storage medium to:
determine, by the modem adjustment engine, that a performance level of the network is below a performance threshold;
detect, by the modem adjustment engine, one or more available networks;
determine, by the modem adjustment engine, a signal strength for the one or more available networks;
select, by the modem adjustment engine, a first available network of the one or more available networks based on a respective signal strength;
compute, by the modem adjustment engine, a second MTU for the first available network; and
connect, by the modem adjustment engine, the endpoint to the first available network via the modem set at the second MTU.

20. The computer-readable storage medium of claim 14, wherein the processor-executable instructions to determine, by the modem adjustment engine, the adjusted MTU for the endpoint based on the connection change cause the one or more processors to further execute processor-executable instructions stored in the computer-readable storage medium to:
incrementally modify, by the modem adjustment engine, a packet size to identify a test MTU at which fragmentation of data ceases;
determine, by the modem adjustment engine, a buffer MTU amount; and
compute, by the modem adjustment engine, the adjusted MTU based on the test MTU at which fragmentation of data ceases and the buffer MTU amount.
